(19) United States
(12) Patent Application Publication
(10) Pub. No.: US 2007/0212268 A1
(43) Pub. Date: Sep. 13, 2007

(54) Laboratory-scale hydrogenation cartridge reactor for hydrogenating an inflowing multi-component fluid composition

(75) Inventors: Ferenc Darvas, Budapest (HU); Lajos Godorhazy, Erd (HU); Tamas Karancsi, Budapest (HU); Daniel Szalay, Budapest (HU); Ferenc Boncz, Budapest (HU); Laszlo Urge, Budapest (HU)

Correspondence Address: YOUNG & THOMPSON, 745 SOUTH 23RD STREET, 2ND FLOOR, ARLINGTON, VA, 22202, US

(73) Assignee: THALESNANO ZRT., BUDAPEST (HU)

(21) Appl. No.: 11/709,258

(22) Filed: Feb. 22, 2007

Related U.S. Application Data
(63) Continuation-in-part of application No. PCT/HU05/00090, filed on Aug. 23, 2005.

(30) Foreign Application Priority Data
Aug. 23, 2004 (HU) P0401726

(51) Int. Cl. B01J 8/18

(52) U.S. Cl. 422/139

(57) ABSTRACT

A laboratory-scale hydrogenation cartridge reactor for hydrogenating an inflowing multi-component fluid composition includes a flow inlet defining an inflow cross-section and used for introducing the fluid composition, a flow outlet defining an outflow cross-section for discharging the hydrogenated fluid, a closed reaction volume extending between and communicating with the inlet and outlet and having a useful space of at most 10 cm³. The reaction volume is filled with an immobilized packing medium that increases flow resistance and facilitates mixing of the fluid composition. The flow inlet and the flow outlet are formed with respective detachable connection structures. A steep transitional zone is defined between the inflow side of the reaction volume and the flow inlet, wherein the cross-section of the widest portion of the steep transitional zone where the zone communicates with the reaction volume is significantly larger than the inflow cross-section.

The invention relates to a laboratory-scale hydrogenation cartridge reactor for hydrogenating an inflowing multi-component fluid composition, particularly for use in a flow-type hydrogenation apparatus.

Hydrogenating processes (from now on, hydrogenation) are used in the chemical synthesis of organic compounds: hydrogen is incorporated into starting molecules—optionally in the presence of a catalyst—at given positions and thereby qualitatively different molecules are generated from the starting molecules. Hydrogenation is widely used by the modern chemical industry (including also pharmaceutical industry). Accordingly, a variety of apparatuses, so-called hydrogenation reactors have been developed for implementing hydrogenating processes. These apparatuses serve, however, for carrying out generally hydrogenation on industrial scale and hence one of their common features is the relatively large size and the immobility originating from the size.

Due to the rapid spread of combinatorial chemical methods, nowadays the synthesis used by the pharmaceutical industry and the laboratory assaying are increasingly becoming the potential application fields of hydrogenation. In case of these new fields of application the emphasis is laid on the derivatisation of several (or many) substances in tiny amounts separately but rapidly and, if possible, in an automated manner, instead of preparing a single substance in a great amount. The hydrogenation apparatuses that satisfy the requirements concerned should have a small size and, in case of need, be suitable for accomplishing several, even highly different types of homogeneous or inhomogeneous catalytic hydrogenation within a short period of time. In order to carry out different types of reactions rapidly after each other, there is a need for the fast change of the substance to be hydrogenated (from now on, sample material)—especially in case of a selective catalytic hydrogenation process—and there is also a need for changing the catalyst itself which, if possible, should be accomplished without interrupting the operation of the hydrogenation apparatus. Therefore, the catalyst should be easily accessible and rapidly removable, and it should promote the chosen hydrogenation reaction at the highest possible efficiency in a relatively small volume. Such a laboratory-scale hydrogenation apparatus has been described in our co-pending international patent application published under the number WO 2005/107936 A1.

In such a laboratory-scale hydrogenation apparatus the main purpose lies in to establish and/or to ensure optimum conditions required for the hydrogenating process and for achieving this objective a way should be provided by which such conditions can be adjusted. Such parameters are e.g. the temperature and the pressure prevailing within the reactor used for accomplishing the reactions. The reaction depends also on the degree how the sample material and the gaseous hydrogen (together reactants) are mixed. In case of a flow-type hydrogenation process, the components are predominantly mixed in the reactor space and the quality of the mixing depends on the time that the reactants spend in the reactor, that is the so-called residence time: the longer it is, the more complete the planned hydrogenation reaction will be. By providing a suitable flow resistance within the reactor, the level of mixing and the residence time can be significantly increased which finally improves the yield of the hydrogenation process. Such an increased flow resistance affects, however, the pressure by which the fluid can be passed through the reactor.

The review article of G. Jas and A. Kirsching [Chem. Eur. J 2003, vol. 9, pages 5708 to 5723] summarizes the latest developments in the field of flow-through processes, wherein among other means several flow-through type laboratory-scale organic synthesis processes have been shown. In particular, the process of transfer hydrogenation is mentioned as an example, however, detailed analysis of neither the reaction process nor the means for carrying it out is provided. In all systems discussed the flow rate of the fluid was the same in all segments of the systems.

The article deals in detail with applications of reactions and multistep syntheses in flow-through modules, wherein various difficulties have been listed including the need of adjusting almost identical reaction times for the different transformations. If the required reaction time is too long for being achieved in a single pass through, the systems are operated in a circulating mode, wherein the same liquid volume is passed through the reaction spaces several times.

The need for recirculating the fluid has also been mentioned in connection with a laboratory-scale continuous flow process illustrated in FIG. 4, wherein a replaceable reaction chamber was illustrated that was equipped with respective HPLC connectors at both ends and filled with an immobilized packing medium. This chamber had a cylindrical design with an even cross-section between its flow inlet and outlet to fit to the general requirements of the flow-through systems.

This kind of flow-through reaction chamber cannot be used in laboratory-scale hydrogenating equipments such as the type referred to in the cited international publication, as in such equipment the fluid cannot be passed through the reaction volume several times and the parameters cannot be adjusted freely owing to the substantially even flow rate in different segments of the flow-through reactor.

The object of the present invention is to provide an easily replaceable laboratory-scale hydrogenation cartridge reactor, which can be designed to the optimum conditions of any required laboratory-scale hydrogenating process so that if a different reaction is to be carried out, the cartridge can be simply replaced with a different one optimized for this latter reaction.

The invention has been realized with the laboratory-scale cartridge reactor as defined in the attached claims.

In particular, the inflow cross-section of the laboratory-scale cartridge reactor according to the present invention is small and then goes through a sudden increase as the reactor itself rapidly broadens. This broadening takes place in a very short length of the reactor resulting in a steep transitional zone within the cartridge reactor. As a consequence of the broadening, on the one hand the flow rate of the multi-component fluid composition will be significantly smaller within the reaction volume than at the flow inlet. On the other hand, due to the sudden increase in the inner cross-section, strong turbulence develops in the transitional zone that leads to an intense mixing of the components in the composition. The residence time will be much greater within the reaction volume than in the tubes of the hydrogenating apparatus and can be adjusted by means of the pressure generated in the system. Hence, the flow rate can be freely set and adjusted.

As a consequence of the characteristic change in the size of inner cross-section of the cartridge reactor according to the present invention and of the difference in the flow rate within different segments of a system using such reactor, the present laboratory-scale cartridge reactor cannot be considered as a traditional flow-through reactor, wherein the flow cross-section is considered to be essentially constant.

The invention will now be explained in detail with reference to the accompanied drawings, wherein

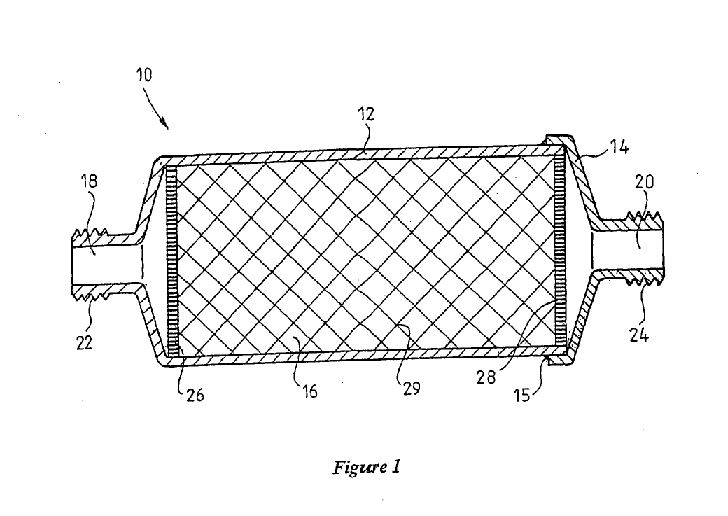

FIG. 1 shows a sectional view of a replaceable cartridge reactor along its longitudinal axis according to the invention in its assembled form.

FIG. 1 illustrates a cartridge reactor 10 for a laboratory-scale hydrogenation apparatus. The cartridge reactor 10 has a casing equipped with an inlet 18 and an outlet 20, wherein the casing is formed from an envelope 12 and an end-plate 14 being combined preferably by means of a pressure-tight connection, eg. a welding or a brazing/soldering joint 15. The casing of the cartridge reactor 10 is preferably pressure-tight and is made of acid- and corrosion-resistant steel, and encloses a reaction volume 16. When assembled, the cartridge reactor 10 forms preferentially a tubular (preferably a cylindrical) element.

The cartridge reactor 10 is formed with a structure which enables the cartridge reactor 10 to be connected into the flow path a flow-type laboratory-scale hydrogenation apparatus. Accordingly, in a possible embodiment of the cartridge reactor 10, the outer surfaces of the inlet 18 and the outlet 20 are provided with threads 22 and 24, respectively, for the connection with the laboratory-scale apparatus via a flare joint equipped with a proper sealing. Other detachable joining mechanisms (eg. an instant fitting system made of acid- and corrosion-resistant steel) known by a person skilled in the relevant field can equally be used for the replaceable connection of the cartridge reactor 10 into the flow path.

The cartridge reactor 10 is equally appropriate for performing homogeneous and heterogeneous hydrogenation. An immobilized packing medium 29 (that is, a medium being incapable of leaving the cartridge reactor 10 together with the through-flowing sample solution) is arranged within the reaction volume 16 of the cartridge reactor 10 which significantly increases the residence time spent by the fed sample solution within the cartridge reactor 10. The immobility of the packing medium 29 is accomplished eg. by arranging filter elements 26, 28 in the cartridge reactor 10 at the opposite ends thereof, which filter elements 26, 28 do not transmit the packing medium 29. Another way of assuring the immobility of the packing medium 29 is that it is fabricated with a spatially contiguous porous geometrical structure, eg. in the form of a (thick) web built up of a plurality of fibers.

In case of a homogeneous hydrogenation, the packing medium 29 contains no solid catalyst, however, it exerts an increased flow resistance (relative to the one exerted by the empty reaction volume 16) that facilitates the hydrogenation reactions due to the intensive mixing of the fed sample solution and the hydrogen gas.

In case of heterogeneous reactions, the packing medium 29 comprises eg. solid catalyst particles, a web or a mesh of fibers coated with a catalyst or made of a catalyst, tiny beads coated with a catalyst, or any combination thereof, wherein the catalyst supporting elements are preferably inert to the hydrogenation reaction to be carried out. A variant of the packing medium 29 comprising a plurality of tiny beads being in contact with each other and a fine powder of a catalyst filling the empty contiguous space among the beads is especially preferred. Any catalyst can be used as the packing medium 29 or as a part thereof; the catalyst actually used is chosen in accordance with the given hydrogenation process.

The inlet 18 and the outlet 20 are preferentially formed with identical inner diameters, which inner diameter, for maintaining continuously a homogeneous material distribution in cross-section, preferably corresponds to that of the liquid transporting elements used in the hydrogenation apparatus. Accordingly, the inner diameter of the inlet 18 is 0.05 to 1.0 mm, preferably 0.5 mm. The inner diameter of the cartridge reactor 10 is preferably 5 to 10 times as large as that of the inlet 18, it is preferably 4 to 6 mm. The length of the cartridge reactor 10 is 30 to 100 mm, preferably 40 to 60 mm.

The fabrication of the cartridge reactor 10 according to the invention is extremely simple and inexpensive. The envelope 12 equipped with the inlet 18 and the end-plate 14 having the outlet 20, both of the cartridge reactor 10, are manufactured on a production line by a simple mechanical working. After having formed the envelope 12, first the filter element 26 is inserted into the reaction volume 16 and then the packing medium 29 is filled onto it. Then the filter element 28 is arranged on top of the packing medium 29, the end-plate 14 is fitted on the envelope 12 and then these last two elements are combined by a suitable manner, eg. by means of welding, brazing or laser fusing. As a next step, the cartridge reactor 10 is provided by threads 22 and 24 on its inlet 18 and outlet 20, respectively, and the cartridge reactor 10 is closed in an airtight manner for a later use by screwing a cap on each of the threads 22, 24. The airtight closure of the cartridge reactor 10 can also be accomplished by applying a closing foil onto the inlet 18 and the outlet 20 each. Within the framework of a serial fabrication of the cartridge reactor 10, the continuous monitoring of the packing medium's 29 quality (for example, of the maintenance of a constant amount of the catalyst included in the packing medium 29) is also possible. In this way a large-scale manufacturing of such replaceable cartridge reactors 10 is achieved, which reactors after being installed into the flow-type laboratory-scale hydrogenation apparatuses allow the production of hydrogenated product with identical characteristics, provided that the other parameters affecting the course of hydrogenation are left unchanged.

1. A laboratory-scale hydrogenation cartridge reactor (10) for hydrogenating an inflowing multi-component fluid composition, comprising a flow inlet (18) defining an inflow cross-section and used for introducing said fluid composition, a flow outlet (20) defining an outflow cross-section adapted for discharging the hydrogenated fluid, a closed reaction volume (16) extending between and communicating with said inlet (18) and outlet (20) and having a useful space of at most 10 cm³, said reaction volume (16) being filled with an immobilized packing medium (29) that increases flow resistance and facilitates mixing of said fluid composition, and wherein the inlet (18) and the outlet (20) are formed with respective detachable connection structures for the connection of said reactor (10), characterized in that a steep transitional zone is defined between the inflow side of said reaction volume (16) and said flow inlet (18), wherein the cross-section of the widest portion of said steep transitional zone where said zone communicates with said reaction volume (16) is significantly larger than said inflow cross-section for facilitating mixing of the components in said composition and for decreasing the flow rate in said reaction volume (16).

2. The cartridge reactor (10) according to claim 1, characterized in that the packing medium (29) comprises a catalyst.

3. The cartridge reactor (10) according to claim 1, characterized in that said reaction volume (16), said flow inlet (18) and said flow outlet (20) have cylindrical shapes.

4. The cartridge reactor (10) according to claim 3, characterized in that the inner diameter of said widest portion is between 6 to 80 times as large as that of the inflow inlet (18).

5. The cartridge reactor (10) according to claim 1, characterized in that said inflow and outflow cross-sections are substantially equal.

6. The cartridge reactor (10) according to claim 1, characterized in that the inlet (18) and the outlet (20) are formed as male elements of a flare joint.

7. The cartridge reactor (10) according to claim 1, characterized in that the immobilized packing medium (29) is formed by filter elements (26, 28) arranged at both interior ends of said reaction volume (16) and granules between the filter elements (26, 28), wherein the openings of the filter elements (26, 28) are smaller than the average particle size of the granules.

8. The cartridge reactor (10) according to claim 1, characterized in that the immobilized packing medium (29) is formed by a packing with a porous geometrical structure.

9. The cartridge reactor (10) according to claim 7, characterized in that the packing medium (29) is made up of a granulated catalyst.
